(19) United States
(12) Patent Application Publication
(10) Pub. No.: US 2014/0102283 A1
(43) Pub. Date: Apr. 17, 2014

(54) Drum Brush With Hard Secondary Striking Source

(71) Applicant: James Fredrick Shepherd, Woodside, NY (US)

(72) Inventor: James Fredrick Shepherd, Woodside, NY (US)

(21) Appl. No.: 13/960,792

(22) Filed: Aug. 6, 2013

Related U.S. Application Data
(60) Provisional application No. 61/742,225, filed on Aug. 6, 2012.

(51) Int. Cl. G10D 13/00

(52) U.S. Cl. CPC G10D 13/00
USPC 84/422.1

(57) ABSTRACT

A drum brush, comprising a handle having a long axis; a hard secondary strike surface contacted to the handle, protruding further out from the axis of the handle in a direction perpendicular to the long axis of the handle; and bristles connected to the hard secondary strike surface. The hard secondary strike surface may comprise a bead.

### CROSS-REFERENCES TO RELATED APPLICATIONS

The present application claims priority from U.S. Provisional Application Ser. No. ______ filed on Aug. 6, 2012, which is hereby incorporated herein by reference in its entirety.

### TECHNICAL FIELD

The present invention, in some embodiments thereof, relates to drum brushes.

### BACKGROUND OF THE INVENTION

The benefits of the beaded brush is that it provides a brush/stick effect in closer range allowing more dynamic freedom. It is common practice for drummers to use traditional brushes for heavier situations and thus over playing with little response as the brushes are wire bristles. By adding a protruding bead in a relatively close proximity to the user, the user now can hit harder with more response without changing implements. The market has alternate brushes such as a drumstick on the butt end, or multiple beads or a stick nestled within the wires. These alternatives limit the uses of a traditional brush (they can be used for one purpose). In the present invention, the drummer may use in a traditional or non traditional manner without switching the brush around or grabbing multiple implements.

### BRIEF SUMMARY OF EMBODIMENTS OF THE INVENTION

The present invention relates to a drum brush comprising a handle having a long axis; a hard secondary strike surface contacted to the handle, protruding further out from the axis of the handle in a direction perpendicular to the long axis of the handle; and bristles connected to the hard secondary strike surface. The hard secondary strike surface may comprise a bead. Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a preferred embodiment of the drum brush.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

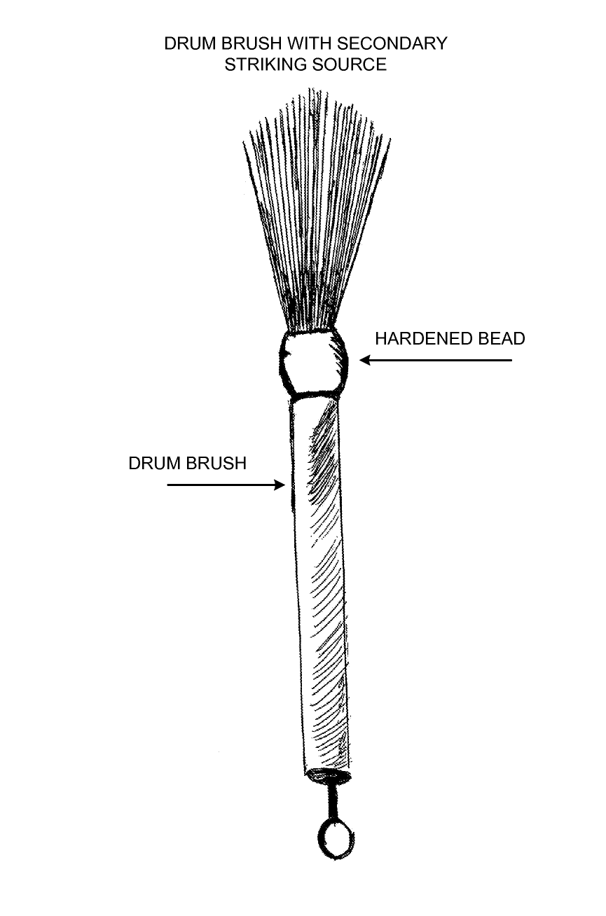

The present invention, in some embodiments thereof, relates to a drum brush. Referring to FIG. 1, the brush comprises a handle having a long axis; a hard secondary strike surface contacted to the handle, protruding further out from the axis of the handle in a direction perpendicular to the long axis of the handle; and bristles connected to the hard secondary strike surface. The hard secondary strike surface may comprise a bead.

While various embodiments of the present invention have been described above, it should be understood that they have been presented by way of example only, and not of limitation Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A drum brush, comprising:
a handle having a long axis;
a hard secondary strike surface contacted to the handle, protruding further out from the axis of the handle in a direction perpendicular to the long axis of the handle; and
bristles connected to the hard secondary strike surface.

2. The drum brush of claim 1, wherein the hard secondary strike surface is bead.
